(19) United States
(12) Patent Application Publication
(10) Pub. No.: US 2008/0122843 A1
(43) Pub. Date: May 29, 2008

(54) MULTI-THREAD VERTEX SHADER, GRAPHICS PROCESSING UNIT AND FLOW CONTROL METHOD

(75) Inventors: Hsine-Chu Chung, Taipei (TW); Ko-Fang Wang, Taipei (TW); Chit-Keng Huang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: VIA TECHNOLOGIES, INC., Taipei (TW)

(21) Appl. No.: 11/458,706

(22) Filed: Jul. 20, 2006

(51) Int. Cl. G06T 15/50; G06F 9/312; G06T 15/00

(52) U.S. Cl. 345/426; 712/214; 345/522; 712/E09.033

(57) ABSTRACT

A logic unit is provided for performing operations in multiple threads on vertex data. The logic unit comprises a macro instruction register file, a flow control instruction register file, and a flow controller. The macro instruction register file stores macro blocks with each macro block including at least one instruction. The flow control instruction register file stores flow control instructions with each flow control instruction including at least one called macro block and dependency information of the called macro block. The flow controller is configured to perform retrieving the flow control instructions in order from the flow control instruction register file, determining at least one macro block of the macro instruction register file to be executed in accordance with the retrieved flow control instruction and the dependency information thereof, selecting one of the plurality of threads for executing the determined macro block in a predetermined thread schedule policy, and accessing vertex data for the threads.

### BACKGROUND OF THE INVENTION

1. Field of the Invention

The present invention relates to a vertex shader, and more specifically to a vertex shader concurrently executing a plurality of threads on single vertex data.

2. Description of the Related Art

As graphics applications increase in complexity, capabilities of host platforms (including processor speeds, system memory capacity and bandwidth, and multiprocessing) also continually increase. To meet increasing demands for graphics, graphics processing units (GPUs), sometimes also called graphics accelerators, have become an integral component in computer systems. In the present disclosure, the term graphics controller refers to either a GPU or graphic accelerator. In computer systems, GPUs control the display subsystem of a computer such as a personal computer, workstation, personal digital assistant (PDA), or any device with a display monitor.

FIG. 1 is a block diagram of a conventional GPU 10, comprising a vertex shader 12, a setup engine 14, and a pixel shader 16. The vertex shader 12 receives vertex data of images and performs vertex processing which may including transforming, lighting and clipping. The setup engine 14 receives the vertex data from the vertex shader 12 and performs geometry assembly wherein received vertices are re-assembled into triangles. Once each of the triangles creating a 3D scene have been arranged, the pixel shader 16 proceeds to fill them with individual pixels and to perform a rendering process including determining color, depth values, and position on screen with textures for each pixel. The output of the pixel shader 16 can be shown on a display device.

FIG. 2 is a detailed block diagram of the vertex shader 12 shown in the FIG. 1. The vertex shader 12 is a programmable vertex processing unit, performing user-defined operations on received vertex data. The vertex shader 12 comprises an instruction register 22, a flow controller 24, an arithmetic logic unit (ALU) pipe 26, and an input register 28. Basic instructions can be combined into a user-defined program performing operations on vertex data stored in the input register 28. The instructions are stored in the instruction register 22 successively. The flow controller 24 reads the instructions out from the instruction register 22 in order. Meanwhile, the flow controller 24 accesses the vertex data from an input register 28 and determines the dependency among the instructions fetched from the instruction register 22. After the dependency check, the flow controller 24 dispatches the instruction ready for the ALU pipe 26 to perform three-dimensional (3D) graphics computations including source selection, swizzle, multiplication, addition, and destination distribution, wherein the ALU pipe 26 reads the vertex data as necessary from the input register 28.

The instructions stored in the instruction register 22 comprise instructions 0, I1 . . . In. If there is no dependency relation thereamong, the flow controller 24 dispatches the instructions I0. In to the ALU pipe 26 in turn. FIG. 3A shows the order of instructions dispatched to the ALU pipe 26 in each time slot during a period of 4 time slots, T0 to T3, and there is no dependency relation thereamong. However, if the instruction I1 is dependent on instruction I0 as follows:

I₀: Mov TR0 C0;

I₁: Mad OR0 TR0 IR0 C1;

The source TR0 of the instruction I₁ is the destination TR0 of instruction I₀. While instruction I₁ cannot be executed until completion of instruction I₀, bubbles appear in the ALU pipe 26, degrading execution efficiency. Assuming the execution time per instruction endures 4 time slots, FIG. 3B shows instructions Ached to the ALU pipe 26 in each time slot with a dependency between instructions I0 and I1. Obviously, bubbles appear in time T1˜T3 when there is a dependency between instructions, I₀ and I₁. Thus, it is necessary to solve the above problem for improving the execution efficiency of the conventional vertex shader 12.

### BRIEF SUMMARY OF INVENTION

A detailed description is given in the following embodiments with reference to the accompanying drawings.

The invention is generally directed to a vertex shader concurrently executing a plurality of threads on vertex data. An exemplary embodiment of a logic unit for performing operations in a plurality of threads on vertex data, comprising a macro instruction register file for storing a plurality of macro blocks, each comprising a plurality of instructions; a flow control instruction register file for storing a plurality of flow control instructions, each flow control instruction comprising at least one called macro block and dependency information of the called macro block; and a flow controller is configured to perform retrieving the flow control instructions in order from the flow control instruction register file, determining at least one macro block of the macro instruction register file to be executed in accordance with the retrieved flow control instruction and the dependency information thereof, selecting one of the plurality of threads for executing the determined macro block in a predetermined thread schedule policy, and accessing vertex data for the threads.

A graphics processing unit (GPU) is provided according to another embodiment of this invention. The GPU comprises a vertex shader configured to concurrently executing a plurality of threads for a plurality of macro blocks consisting of instructions on a segment of the image data, wherein each macro block being executed by each corresponding thread; a setup engine assembling the image data received from the vertex shader into triangles; and a pixel shader receiving the image data from the setup engine and performing a rendering process on the image data to generate pixel data.

In another embodiment of this invention, a flow control method is also provided for concurrently executing a plurality of threads on vertex data and a plurality of macro blocks and a plurality of flow control instructions. Each macro block comprises a plurality of instructions. Each flow control instruction calls at least one of the macro blocks and comprises dependency information of the called macro block. The flow control method comprises retrieving one flow control instruction, determining a macro block to execute in accordance with the retrieved flow control instruction and the dependency information thereof, selecting one thread to execute for the determined macro block according to a predetermined thread schedule policy, and accessing the vertex data for the selected thread.

### BRIEF DESCRIPTION OF DRAWINGS

The invention can be more fully understood by reading the subsequent detailed description and examples with references made to the accompanying drawings, wherein:

FIG. 1 is a block diagram of a conventional graphics processing unit (GPU).

FIG. 2 is a block diagram of the vertex shader of FIG. 1.

FIG. 3A is a schematic diagram illustrating the order of instructions dispatched to the ALU pipe in FIG. 1, when there is no dependent relation between instructions.

FIG. 3B is a schematic diagram illustrating the order of instructions dispatched to the ALU pipe in FIG. 1, when there is a dependent relation between instructions.

FIG. 4 is a block diagram of a vertex shader according to an embodiment of the invention.

FIG. 5 is a schematic diagram illustrating the format of the flow control instruction of the flow control instruction register in FIG. 4.

FIG. 6 is a block diagram of the vertex shader in FIG. 4, comprising 6 threads.

FIG. 7 shows exemplary macro blocks and flow control instruction register in FIG. 4.

FIGS. 8A˜8D are schematic diagrams illustrating the order of instructions dispatched to the ALU pipe in FIG. 4 with the macro blocks and flow control instruction register in FIG. 7.

FIG. 9 is a block diagram of a GPU according to another embodiment of the invention.

FIG. 10 is a flowchart of a flow control method for a vertex shader capable of concurrently executing a plurality of threads on a vertex data according to another embodiment of the invention.

FIG. 11 is a detailed flowchart of a flow control method for a vertex shader according to another embodiment of the invention.

### DETAILED DESCRIPTION OF INVENTION

The following description comprises the best-contemplated mode of carrying out the invention. This description is made for the purpose of illustrating the general principles of the invention and should not be taken in a limiting sense. The scope of the invention is best determined by reference to the appended claims.

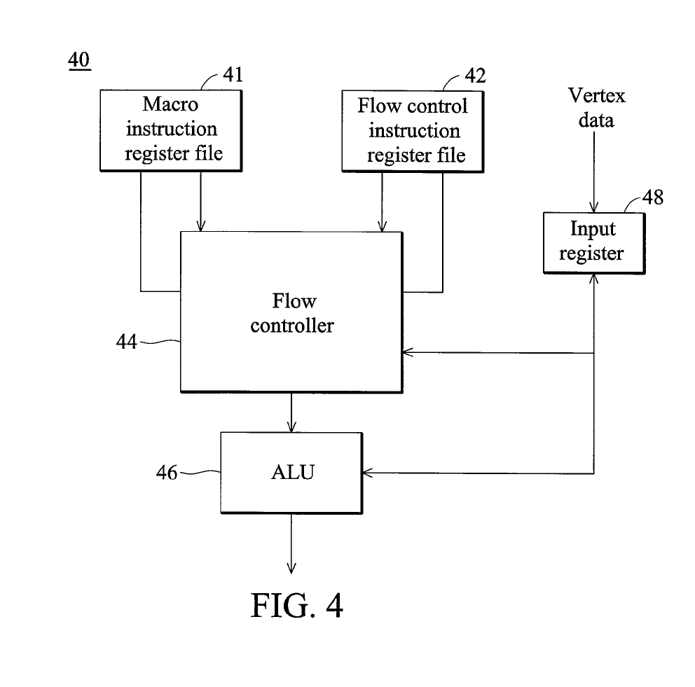

FIG. 4 shows a vertex shader 40 according to an embodiment of the invention. The vertex shader 40 comprises a macro instruction register file 41, a flow control instruction register file 42, a flow controller 44, an arithmetic logic unit (ALU) pipe 46, and an input register 48. Here, macro instruction register file 41 and flow control instruction register file 42 may respectively comprise a plurality of registers. The macro instruction register file 41 stores a plurality of macro blocks, each comprising at least one instruction. The transforming and lighting operations on vertex data executed by the vertex shader 40 could be categorized into several macro blocks of arithmetic operations with respect to the functions of the macro blocks. For example, one of the macro blocks may comprise instructions performing transforming operations and another macro block may comprise instructions performing lighting operations. The transforming and lighting operations may be categorized into other functions, such as number of lights, direction of light, point light and so on. Moreover, the macro blocks may comprise both non-preemptive and preemptive macro blocks, wherein the instructions of the non-preemptive macro block are independent of each other, and at least one instruction of the preemptive macro block is dependent upon the instructions in the same macro blocks.

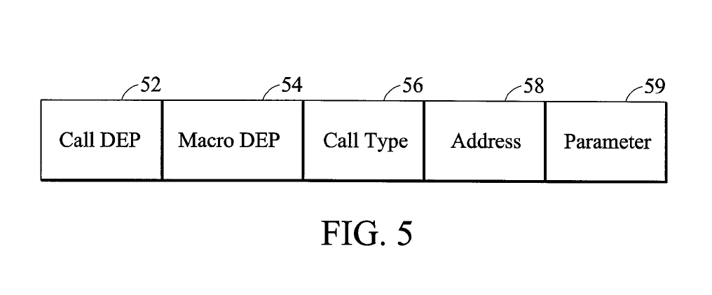

The flow control instruction register file 42 stores a plurality of flow control instructions controlling the flow of the transforming and lighting operations executed by the vertex shader 40. The flow control instructions function as subroutine calls, each calling a subroutine, wherein the subroutines correspond to the macro blocks of the macro instruction register file 41. Moreover, the flow control instruction comprises dependency information of the called macro block, wherein the dependency information for the called macro block comprises block dependency information between the called macro block and other macro blocks and instruction dependency information between the instructions within the called macro block. FIG. 5 shows an example format of the flow control instruction. Each flow control instruction includes several fields such as Call DEP field 52, Macro DEP field 54, Call Type field 56, Pointer field 58, and Parameter field 59. The Call DEP field 52 in the flow control instruction format is used to indicate the dependency information between the called macro block and other macro blocks. The Macro DEP field 54 in the flow control instruction format indicates which instruction in the called macro block is dependent within current called instruction. The Call Type field 56 thereof indicates whether the macro block called by the flow control instruction is preemptive or non-preemptive. The Pointer field 58 indicates the memory address of the called macro block. The Parameter field 59 indicates the values of coefficients of the flow control instruction. The input register 48 stores the vertex data.

The flow controller 44 executes a plurality of threads on a single vertex data concurrently. In addition, the flow controller 44 retrieves the flow control instructions in order from the flow control instruction register file 42. Next, the flow controller 44 determines a macro block to execute according to the Pointer field of the retrieved flow control instruction and selects a thread for the macro block to execute according to a predetermined thread schedule policy. For example, if there are six threads Th0˜Th5 executed in the vertex shader 40, the flow controller 44 selects the threads to execute macro blocks in the order of Th0, Th1, Th2, Th3, Th4, and Th5. After selecting thread Th5, the flow controller 44 selects thread Th0. The flow controller 44 checks the dependency information of the macro block called by the flow control instruction in the Call DEP field 52, Macro DEP field 54, and Call Type field 56 of the flow control instruction. The arithmetic logic unit (ALU) pipe 46 receives and stores the vertex data from the input register 48, executing the instructions of the threads selected by the flow controller 42 for three-dimensional (3D) graphics computations, which may include source selection, swizzle, multiplication, addition, and destination distribution.

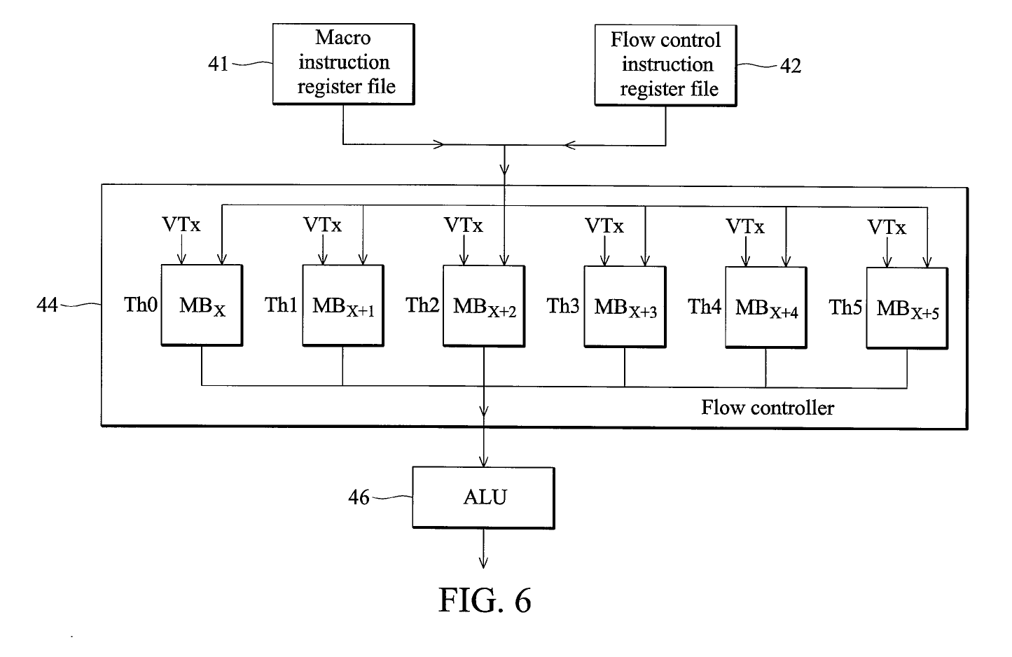

In one example of the embodiment, six threads Th0˜Th5, provided by the flow controller 44 and corresponding to macro blocks MB_{N}˜MB_{N+5} of the macro instruction register file 41 respectively execute transforming and lighting operations on vertex data VTx as shown in FIG. 6, each thread executing operations on the same vertex data VTx. Since the transforming and lighting operations on vertex data are divided into several arithmetic operations corresponding to the macro blocks, MB_{N}˜MB_{N+5}, of the macro instruction register file 41, each thread in the flow controller 44 corresponding to a macro block performs transforming and lighting operations on the same vertex data until the transforming and lighting operations are completed.

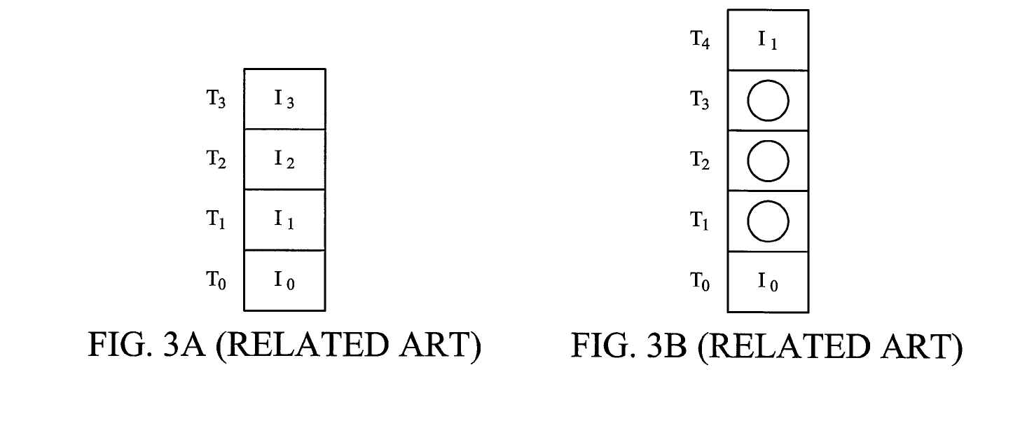

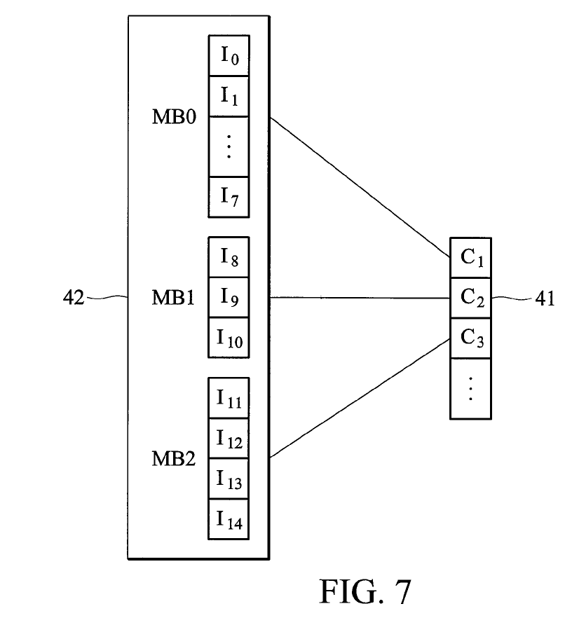

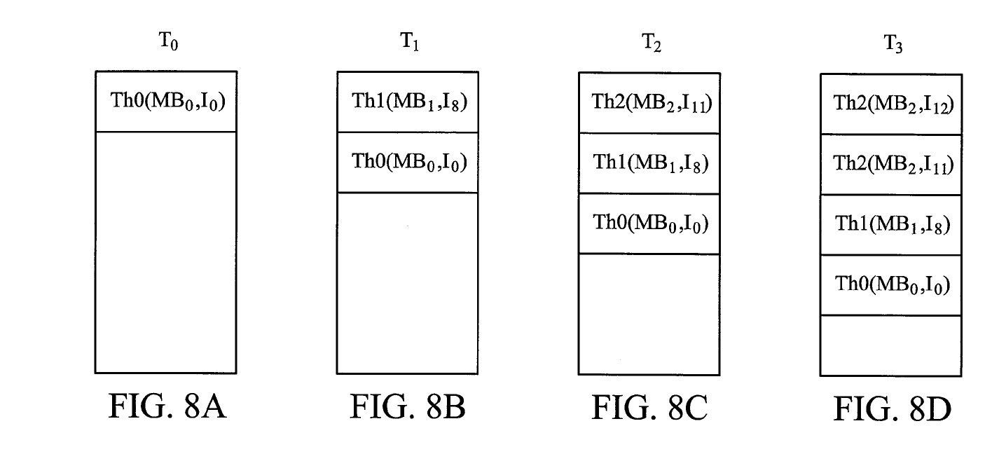

Moreover, the flow controller 44 selects the threads Th0→Th5 for the macro blocks in a predetermined thread scheduling policy, for example, a Round-Robin policy as shown of Th0→Th1→Th2→Th3→Th4→Th5→Th0. FIG. 7 shows an exemplary flow control instruction register file 42 and macro blocks of the macro instruction register file 41. As shown, the flow control instruction register file 42 comprises flow control instruction C1, C2, and C3, wherein the flow control instructions C1, C2, and C3 call the macro blocks MB0, MB1, and MB2 of the macro instruction register file 41, respectively. The macro blocks MB0, MB1 and MB2 include instructions I₀˜I₇, I₈˜I₁₀, and I₁₁˜I₁₄, respectively. If instruction I₁ is dependent on instruction I₀ and instruction I₉ is dependent on instruction I₈, the execution order of threads, macro blocks and instructions in the ALU pipe 46 in each time slot is as shown in FIG. 8A to 8D. As shown in FIG. 8A, the flow controller 44 determines the macro block MB0 to be executed according to the address information of the flow control instruction C1. The flow controller 44 further selects thread Th0 to execute the macro block MB0. Hence the flow controller 44 dispatches the instruction I₀ of Macro block MB0 in the thread Th0 at time T0. At next time slot T1, the flow controller 44 is set to dispatch I₁ of the macro block MB0 in thread th0 to the ALU pipe 46, however, since the instruction I₁ is dependent on instruction I₀, the flow controller 44 retrieves next flow control instruction C2 from the flow control instruction register file 42. The flow controller 44 further determines the Macro block MB1 to be executed according to the address information of the flow control instruction C2 and selects thread Th1 to execute the Macro block MB1 according to the predetermined thread scheduling policy. In one example of this embodiment, the pre-determined thread schedule policy could be followed a Round Robin policy, which is well-known thread scheduling mechanism. Thus the flow controller 44 dispatches the instruction I₈ of Macro block MB1 in the thread Th1 at time T1 as shown in FIG. 8B. Similarly, at subsequent time slot T2, the flow controller 44 dispatches the instruction I₉ of Macro block MB1 in the thread Th1 to the ALU pipe 46. However, since instruction I₉ is dependent on instruction I₈, the flow controller 44 retrieves next flow control instruction C3 from the flow control instruction register file 42. The flow controller 44 further determines the Macro block MB2 to execute according to the address information of the flow control instruction C3 and selects thread Th2 for the Macro block MB2 to execute according to the predetermined thread scheduling policy. Thus, the flow controller 44 dispatches the instruction I₁₁ of Macro block MB2 in the thread Th2 at time T2 as shown in FIG. 8C. Since there is no dependency relation between instructions within the Macro Block MB2, the flow controller 44 dispatches the second instruction I₁₂ of the Macro Block MB2 to the thread T3 at time T3 as shown in the FIG. 8D. At time T3, FIG. 8D shows the execution sequence with respect to the threads, macro blocks and instructions of the ALU pipe 46. Comparing FIG. 3B with 8D, it is found that the bubbles of FIG. 3B do not occur with the embodied vertex shader 40 in accordance with the invention, indicating improved performance of the vertex shader 40.

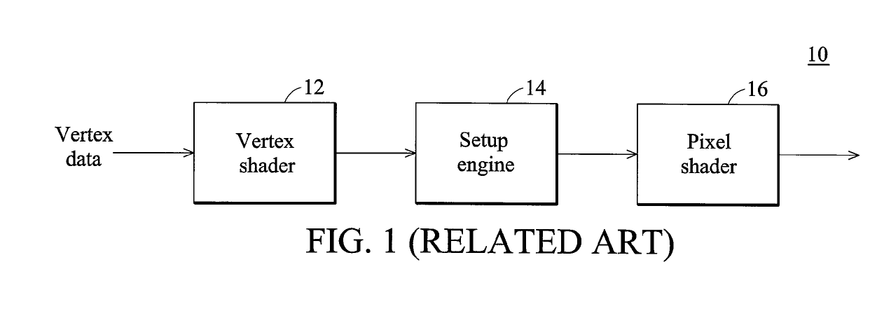

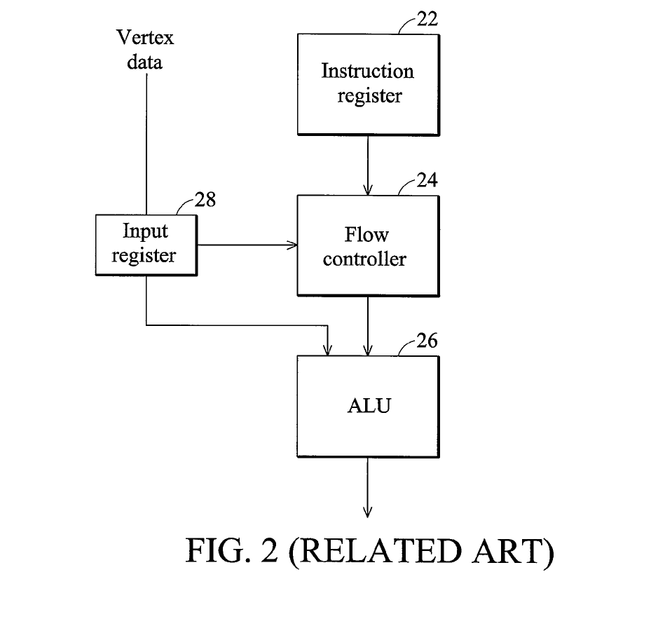

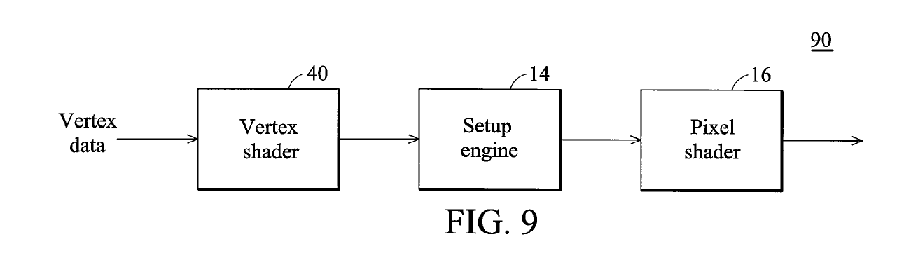

FIG. 9 shows a graphics processing unit (GPU) 90 according to another embodiment of the invention. The GPU 90 is similar to the GPU 10 in FIG. 1 except for the vertex shader 40. FIG. 9 uses the same reference numerals as FIG. 1 on common elements which perform the same functions, and thus are not described in further detail. The GPU 90 utilizes the vertex shader 40 in accordance with the invention as shown in FIG. 4. The operation of the vertex shader 40 is described previously, and thus is not further described.

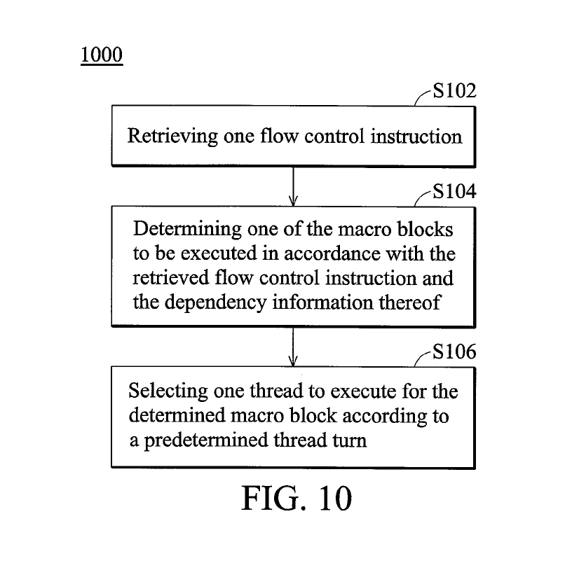

FIG. 10 is a flowchart of a flow control method 1000 for a vertex shader according to an embodiment of the invention. The vertex shader concurrently executes a plurality of threads on vertex data and comprises a macro instruction register file and a flow control instruction register file. The macro instruction register file stores a plurality of macro blocks, each macro block comprising a plurality of instructions. The flow control instruction register file stores a plurality of flow control instructions, each flow control instruction calling one of the macro blocks and comprising dependency information of the called macro block. One flow control instruction is retrieved from the flow control instruction register file (step 102) One of the macro blocks to be executed is determined in accordance with the retrieved flow control instruction and the dependency information thereof (step 104). With the address information of the retrieved flow control instruction, the macro block called thereby can be determined and a thread is selected to execute the called macro block according to a thread scheduling policy (step 106). The vertex data is accessed by the selected thread. Moreover, with the dependent information with respect to the called macro block in the retrieved flow control instruction, the method 1000 returns to step 102 to retrieve a next flow control instruction if the determined macro block is dependent, and determine a macro block to execute therefor accordingly in step 104. A thread for the macro block of the next flow control instruction is further selected according to the predetermined thread schedule policy in step 106. Once the selection in step 106 is completed, the instructions of the selected thread are dispatched.

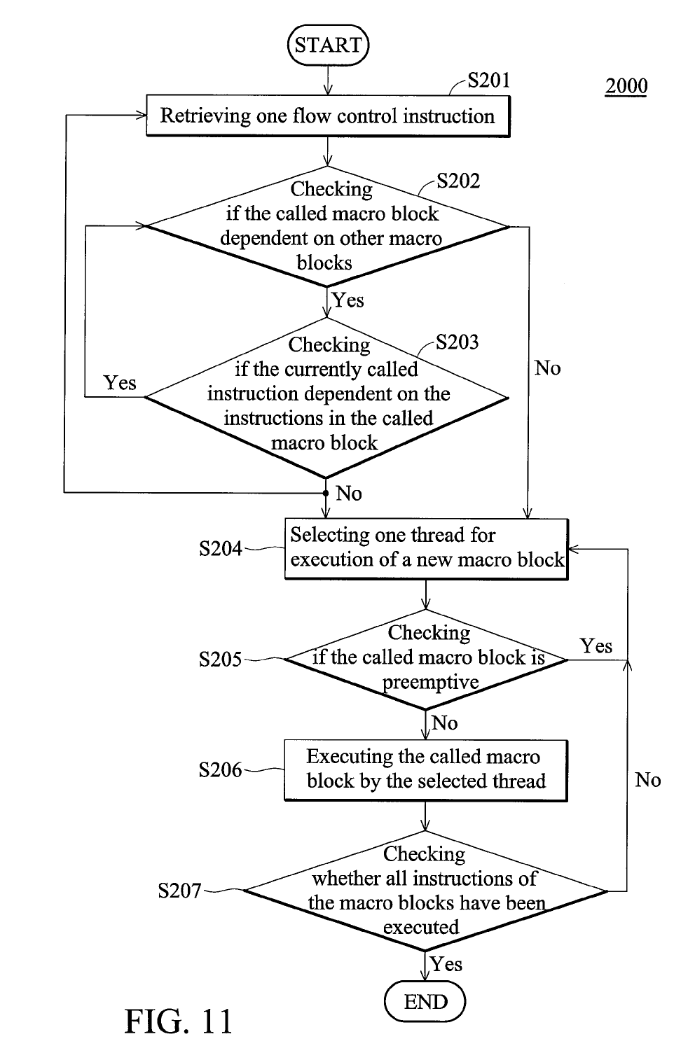

FIG. 11 is a detailed flowchart of a flow control method 2000 for a vertex shader according to another embodiment of the invention. First, one flow control instruction is retrieved (S201). Next, block dependencies among the called macro block and other macro blocks is checked according to the block dependency information in the Call DEP field 52 (S202). If the called macro block is dependent to other macro blocks, the instruction dependency among the currently called instruction and the instructions in the called macro block is checked according to the instruction dependency information in the Macro DEP field 54 (S203). If the called instruction is dependent to the instructions in the same called macro block, the process returns to step S202 to check the block dependency again. In the determination of step S202, if no dependency is detected among the called macro block and other macro blocks, one thread is selected for execution of a new macro block (S204). In the determination of step S203, if no dependency is detected among the called instruction and other instructions in the called macro block, the process goes to step S204 to select one thread for execution of a new macro block, and returns to step S201 to retrieve another flow control instruction. After a thread for execution of new macro block is selected in step S204, preemptive of the called macro block is checked (S205). As described, the instructions of a non-preemptive macro block are independent of each other, and at least one instruction of a preemptive macro block is dependent upon the instructions of the same called macro blocks. If the called macro block is non-preemptive, the called macro block is executed by the selected thread (S206). If not, the process waits for a while and repeats to the check step 205 itself. Until the depended instruction is executed completely, the flow continues to step 207. At last, the process checks whether all instructions of the macro blocks have been executed (S207). If not, the process returns to step S204 to select another thread for execution of a new macro block. If so, the process of flow control method 2000 is completed.

In the invention, a vertex shader concurrently executes a plurality of threads on vertex data, each thread corresponding to a macro block in the macro instruction register file. The performance of the ALU pipe in a GPU is thus improved, especially when there is dependency of instructions for the vertex shader to execute. As a result, the GPU executes instructions of other threads corresponding to other macro blocks when there is dependency found in instructions of the macro blocks.

While the invention has been described by way of example and in terms of the preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A logic unit for performing operations in a plurality of threads on vertex data, comprising:
a macro instruction register file for storing a plurality of macro blocks, each comprising a plurality of instructions;
a flow control instruction register file for storing a plurality of flow control instructions, each flow control instruction comprising at least one called macro block and dependency information of the called macro block; and
a flow controller configured to perform retrieving the flow control instructions in order from the flow control instruction register file, determining at least one macro block of the macro instruction register file to be executed in accordance with the retrieved flow control instruction and the dependency information thereof, selecting one of the plurality of threads for executing the determined macro block in a predetermined thread schedule policy, and accessing vertex data for the threads.

2. The logic unit as claimed in claim 1, further comprising an arithmetic logic unit (ALU) pipe for receiving the vertex data for executing the instructions of the macro block determined by the flow controller in the selected thread for three-dimensional (3D) graphics computations.

3. The logic unit as claimed in claim 1, wherein the dependency information for the called macro block comprises information being selected from a group of:
dependency information between the called macro block and other macro blocks; and
dependency information between the instructions of the called macro block.

4. The logic unit as claimed in claim 1, wherein the macro blocks comprise non-preemptive and preemptive macro blocks, and wherein the instructions of the non-preemptive macro block are independent of each other in the non-preemptive macro block, and at least one instruction of the preemptive macro block is dependent upon the instructions of the same macro blocks.

5. The logic unit as claimed in claim 1, wherein the flow controller is further configured to perform retrieving a next flow control instruction from the flow control instruction register file and selecting another thread for the macro block called by the next flow control instruction according to the predetermined thread schedule policy if the called macro block of the retrieved flow control instruction being determined, by the flow controller, to be dependent on other macro block.

6. The logic unit as claimed in claim 5, wherein the flow controller is further configured to determine that whether the macro block called by the retrieved flow control instruction being dependent on other macro block according to the dependency information of the retrieved flow control instruction.

7. The logic unit as claimed in claim 2, further comprising an input register, coupled to flow controller and the ALU pipe, storing vertex data.

8. The logic unit as claimed in claim 1, wherein operations performed in the plurality of threads are divided into the plurality of macro blocks according to functions thereof.

9. A graphics processing unit (GPU) comprising:
a vertex shader is configured to concurrently executing a plurality of threads for a plurality of macro blocks consisting of instructions on a segment of the image data, wherein each macro block being executed by each corresponding thread;
a setup engine assembling the image data received from the vertex shader into triangles; and
a pixel shader receiving the image data from the setup engine and performing a rendering process on the image data to generate pixel data.

10. The graphics processing unit (GPU) as claimed in claim 9, wherein the vertex shader comprises:
a macro instruction register file for storing the plurality of macro blocks;
a flow control instruction register file for storing a plurality of flow control instructions, each flow control instruction comprising at least one called macro block and dependency information of the called macro block;
a flow controller configured to perform retrieving the flow control instructions in order from the flow control instruction register file, determining at least one macro block of the macro instruction register file to be executed in accordance with the retrieved flow control instruction and the dependency information thereof, selecting one of the plurality of threads for executing the determined macro block in a predetermined thread schedule policy, and accessing vertex data for the threads; and
an arithmetic logic unit (ALU) pipe, receiving the vertex data for executing the instructions of the macro block determined by the flow controller in the selected thread for three-dimensional (3D) graphics computations.

11. The graphics processing unit as claimed in claim 10, wherein the dependency information for the called macro block comprises information being selected from a group of:
dependency information between the called macro block and other macro blocks; and
dependency information between the instructions of the called macro block.

12. The graphics processing unit as claimed in claim 10, wherein the macro blocks comprise non-preemptive and preemptive macro blocks, and wherein the instructions of the non-preemptive macro block are independent of each other in the non-preemptive macro block, and at least one instruction of the preemptive macro block is dependent upon the instructions of the same macro blocks.

13. The graphics processing unit as claimed in claim 10, wherein the flow controller is further configured to perform retrieving a next flow control instruction from the flow control instruction register file and selecting another thread for the macro block called by the next flow control instruction according to the predetermined thread schedule policy if the called macro block of the retrieved flow control instruction being determined, by the flow controller, to be dependent on other macro block.

14. The graphics processing unit as claimed in claim 13, wherein the flow controller is further configured to determine that whether the macro block called by the retrieved flow control instruction being dependent on other macro block according to the dependency information of the retrieved flow control instruction.

15. The graphics processing unit as claimed in claim 10, wherein the vertex shader further comprises an input register, coupled to flow controller and the ALU pipe, storing vertex data.

16. The graphics processing unit as claimed in claim 10, wherein operations performed in the plurality of threads are divided into the plurality of macro blocks according to functions thereof.

17. A flow control method for concurrently executing a plurality of threads on vertex data and a plurality of macro blocks and a plurality of flow control instructions, wherein each macro block comprising a plurality of instructions and each flow control instruction calling at least one of the macro blocks and comprising dependency information of the called macro block, the flow control method comprising:
retrieving one flow control instruction;
determining one of the macro blocks to be executed in accordance with the retrieved flow control instruction and a dependency information thereof; and
selecting one thread to be executed for the determined macro block according to a predetermined thread schedule policy.

18. The flow control method as claimed in claim 17, further comprising:
determining the macro block called by the retrieved flow control instruction to be executed and selecting one thread therefor according to the predetermined thread schedule policy.

19. The flow control method as claimed in claim 17, wherein the determining further comprising:
determining that whether the macro block called by the retrieved flow control instruction being dependent on other macro block according to the dependency information of the retrieved flow control instruction.

20. The flow control method as claimed in claim 19, wherein the determining further comprising determining whether a called instruction comprises dependency with the instructions in the called macro block

21. The flow control method as claimed in claim 20, further comprising retrieving another next flow control instruction if a combination of conditions being selected from a group of:
the called macro block being dependent to other macro blocks; and
a current called instruction being dependent to the instructions in the called macro block.

22. The flow control method as claimed in claim 17, wherein the dependency information of the flow control instruction for the macro block called by the flow control instruction comprises information being selected from a group of:
dependency information between the called macro block and other macro blocks; and
dependency information between the instructions of the called macro block.

23. The flow control method as claimed in claim 17, wherein the macro blocks comprise non-preemptive and preemptive macro blocks, and wherein the instructions of the non-preemptive macro block are independent of each other in the non-preemptive macro block, and at least one instruction of the preemptive macro block is dependent upon the instructions of the same macro blocks.

24. The flow control method as claimed in claim 17, wherein the plurality of threads perform operations on the vertex data, and the operations performed in the plurality of threads are divided into the plurality of macro blocks according to functions thereof.
